(19) United States
(12) Patent Application Publication
(10) Pub. No.: US 2002/0064733 A1
(43) Pub. Date: May 30, 2002

(54) Film having a long wavelength filter

(76) Inventor: Lorin C. Nash, Austin, TX (US)

Correspondence Address: SIMON, GALASSO & FRANTZ, PLC., P.O. Box 26503, Austin, TX, 78755-0503, US

(21) Appl. No.: 09/803,419

(22) Filed: Mar. 9, 2001

Related U.S. Application Data
(60) Provisional application No. 60/188,448, filed on Mar. 10, 2000.

(51) Int. Cl. G03C 1/46; G03C 1/815; G03C 1/825

(52) U.S. Cl. 430/507; 430/511; 430/512

(57) ABSTRACT

A photographic film having a long wavelength (LW) filter is disclosed. The LW filter is capable of blocking substantially all light in the infra-red (IR) portion of the light spectrum. In at least one embodiment, the LW filter is further capable of transmitting light in the visible part of the light spectrum. A LW filter may be placed in various positions on a photographic film, and/or included in one of a photographic film's emulsion layers.

### CROSS REFERENCE TO RELATED APPLICATIONS

This application claims the benefit of U.S. Provisional Patent Application Serial No. 60/188,448 filed Mar. 10, 2000 entitled “FILM HAVING A LONG WAVELENGTH FILTER,” of common assignee herewith.

### FIELD OF THE INVENTION

The present invention relates generally to photographic film, and more particularly to filter layers included in photographic films.

### BACKGROUND OF THE INVENTION

Conventional photographic films comprise one or more light-sensitive emulsion layers. These layers are sensitized to respond to certain portions of the visible light spectrum. For example, in a simple color film, blue, green and red light reflected from an object is recorded in corresponding blue, green, and red emulsion layers.

Except in the case of special infra-red (IR) or similar films, most photographic film is designed to form images using primarily light in the visible spectrum, and images formed by light in the non-visible part of the light spectrum are generally undesired. However, in films with emulsion layers that are designed to be particularly sensitive to light in the red portion of the visible light spectrum, it can be difficult to keep IR light from affecting the desired visible light image. In such a case, unless the IR light is somehow prevented from reaching the emulsion layer, undesired image effects may result.

### SUMMARY OF THE INVENTION

Therefore, what is needed is a way to block longer wavelength light, such as light from the infra-red (IR) portion of the light spectrum, from reaching at least some of a film's emulsion layers.

Accordingly, the present invention provides a photographic film comprising at least one light sensitive emulsion layer capable of forming a latent image upon exposure to light, and at least one long wavelength (LW) filter capable of blocking transmission of substantially all light in the infra-red (IR) portion of the light spectrum. In at least one embodiment, the LW filter is also capable of allowing transmission of light in at least a portion of the visible light spectrum. In some embodiments, the LW filter is positioned such that when the film is exposed to light in order to record a latent image, the light passes through the LW filter before reaching the emulsion layers. In other embodiments, the LW filter is positioned so that IR light is prevented from entering or re-entering the emulsion layers from the back of the film.

The present invention also provides a method of constructing photographic film. The method comprises depositing at least one light sensitive emulsion layer onto a photographic film, and depositing at least one long wavelength (LW) filter onto the film. In at least one embodiment, a plurality of light sensitive emulsions is deposited on the film. and the LW filter is included in at least one of the plurality of emulsion layers. The LW filter is capable of blocking transmission of substantially all light in the infra-red (IR) portion of the light spectrum. In at least one embodiment, the LW filter is also capable of allowing transmission of light in at least a portion of the visible light spectrum.

An advantage of at least one embodiment of the present invention is that a photographic film according to the present invention can provide improved image quality.

### BRIEF DESCRIPTION OF THE DRAWINGS

Other objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like Preference numerals designate corresponding parts in the various figures, and wherein:

FIG. 1 is a cross-sectional view of a color film according to at least one embodiment of the present invention, the color film having a long wavelength (LW) filter positioned to prevent infra-red (IR) light from reaching the image-forming emulsion layers during normal exposure;

FIG. 2 is a cross-sectional view of a color film according to another embodiment of the present invention, the color film having a LW filter positioned to prevent light from the IR portion of the light spectrum from reaching the film's emulsion layers from the back;

FIG. 3 is a cross-sectional view of a color film having a combined antihalation layer and LW filter according to one embodiment of the present invention, and

FIG. 4 is a cross-sectional view of a color film having a combined light-sensitive emulsion layer and LW filter, according to one embodiment of the present invention.

### DETAILED DESCRIPTION OF A PREFERRED EMBODIMENT OF THE INVENTION

In the following detailed description of the preferred embodiments, reference is made to the accompanying drawings which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical, chemical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

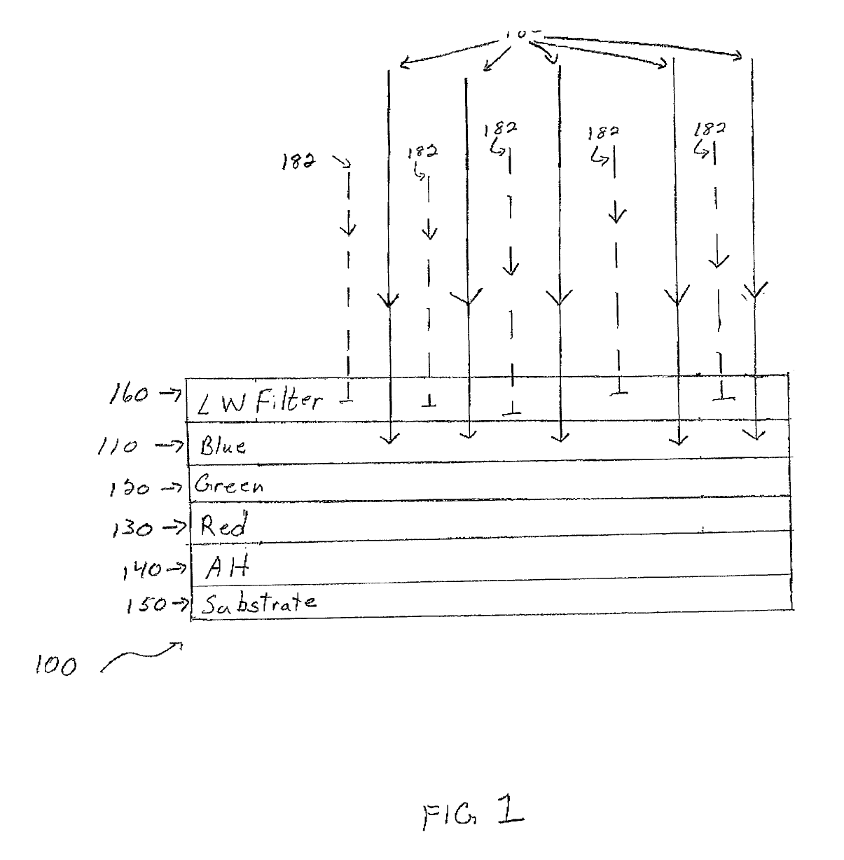

Referring first to FIG. 1, a color film according to one embodiment of the present invention is illustrated, and designated generally as film 100. Film 100 comprises substrate 150, antihalation (AH) layer 140, red emulsion layer 130, green emulsion layer 120, blue emulsion layer 110, and long wavelength (LW) filter 160. Red emulsion layer 130, green emulsion layer 120 and blue emulsion layer 110, are preferably sensitized to react with specific portions of the visible light spectrum, such that when film 100 is exposed to light 180, latent image centers corresponding to the red portion of the visible light spectrum are formed in red emulsion layer 130, latent image centers corresponding to the green portion of the visible light spectrum are formed in green emulsion layer 120, and latent image centers corresponding to the blue portion of the visible light spectrum are formed in blue layer 110.

Those skilled in the art will recognize that one or more of the emulsion layers 130, 120, and 110, may be composed of a number of sub layers. For example, blue emulsion layer 110 may be made up of multiple layers sensitized to different parts of the blue portion of the visible light spectrum. Alternatively, blue emulsion layer 110 may comprise sub-layers having various photographic speeds, or otherwise. Green emulsion layer 120 and red emulsion layer 130 may be similarly constructed. In addition to multiple light-sensitive emulsion layers for recording images, film 100 may also include various filter layers (not shown). These filter layers may be located between emulsion layers, on top of the top-most emulsion layer (in this case blue 110), next to film substrate 150, or otherwise. Other film layers may be located at various points within film 100 as deemed necessary to achieve photographic, processing, or other objectives.

Depending on how film 100 is intended to be used and/or processed, emulsion layers may be ordered differently than illustrated, or fewer emulsion layers may be used consistent with the objects of the present invention. For example, the position of green layer 120 and blue layer 110 may be switched if desired, without departing from the spirit and scope of the present invention. In addition, at least one embodiment of the present invention uses fewer than three emulsion layers to record an image and its associated color information. For example, a single emulsion sensitized to the majority of the visible portion of the light spectrum may be used in place of separately sensitized emulsion layers according to the present invention. Such an emulsion layer is commonly used in Black and White films.

In at least one embodiment of the present invention, AH layer 140 is provided to prevent any visible light 180 and/or IR light 182 that may be transmitted through the film, from being reflected back into emulsion layers 110, 120 and 130, where the reflected light may form an undesired reflected image. The use of antihalation layers to prevent the formation of reflected images is known in the art, and various antihalation layers may be used in accordance with at least one embodiment of the present invention. For example, the present invention may use including antihalation layers formed of a neutral density dye such as those used in the film base of Black and White film, antihalation layers that employ a layer of silver, or otherwise. It will be appreciated that, although not illustrated, AH layer 140 may be coated on the back of film substrate 150 without departing from the spirit and scope of the present invention.

LW filter 160 is also illustrated in FIG. 1, and is provided to block transmission of substantially all light in the IR portion of the light spectrum, and to prevent IR light 182 from reaching emulsion layers 110, 120 and 130. In FIG. 1, LW filter 160 is an independent film layer, and is positioned such that visible light 180 passes through LW filter 160 before reaching emulsion layers 110, 120 and 130 to form a latent image. For the placement of LW filter 160 shown in FIG. 1, LW filter not only blocks transmission of substantially all IR light 182, but passes visible light 180 in order to permit formation of a latent image in blue emulsion layer 110, green emulsion layer 120 and red emulsion layer 130. Preferably, this is accomplished by including IR absorbing dyes in LW filter 160. In some circumstances, it may be desirable for LW filter 160 to allow transmission of IR light 182 and visible light 180 during initial image exposure, but to block transmission of IR light 182 during development. One way to accomplish this is with a pre-fogged IR sensitive emulsion, which does not interfere with visible light 180 during image exposure, but when developed blocks the transmission of IR light 182.

It should also be noted that although a single LW filter 160 is shown, multiple LW filters may be incorporated in accordance with the objectives of the present invention. Each LW filter may be configured to block different portions of IR light 182. For example, LW filter 160 may be configured to block most of the longer wavelength IR light 182, while a second LW filter (not illustrated) may be configured to specifically block portions of IR light 182 which are just beyond the visible spectrum. It will also be appreciated that LW filter 160 may include multiple sub-layers, similar to emulsion layers 110, 120 and 130.

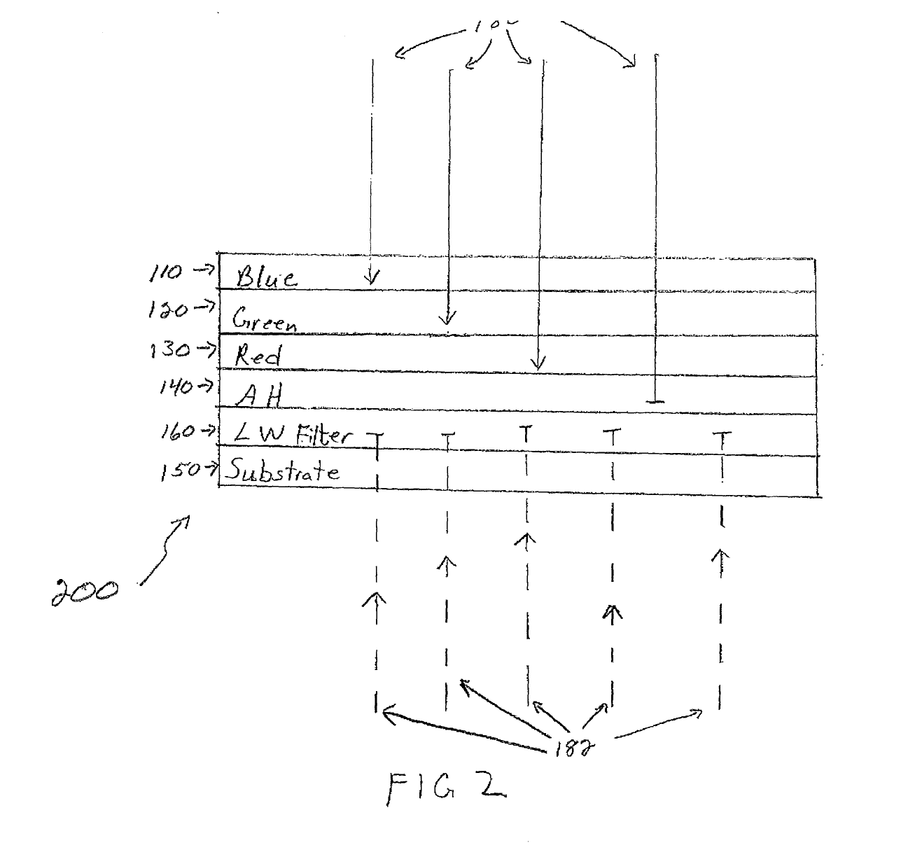

Referring next to FIG. 2, another embodiment of a film according to the present invention is illustrated, and designated generally as color film 200. Reference numerals in FIG. 2 which are like, similar, or identical to reference numerals in FIG. 1 represent like, similar, or identical features. Color film 200 includes blue emulsion layer 110, green emulsion layer 120, red emulsion layer 130, antihalation (AH) layer 140, long wavelength (LW) filter 160, and substrate 150. The functions and attributes of each of these elements has been discussed with reference to FIG. 1. However, unlike the embodiment illustrated in the previous figure, LW filter 160 is placed behind emulsion layers 110, 120 and 130, rather than in front. As a result, when color film 200 is exposed to light in order to form an image, visible light 180 need not pass through LW filter 160 in order to reach blue emulsion layer 110, green emulsion layer 120 or red emulsion layer 130. By placing LW filter 160 as illustrated in FIG. 2, substantially all IR light 182 illuminating the back side of color film 200 is prevented from reaching emulsion layers 110, 120 and 130. This is particularly useful when it is desired to prevent exposure of emulsion layers 110, 120, and 130 to IR light 182 during processing.

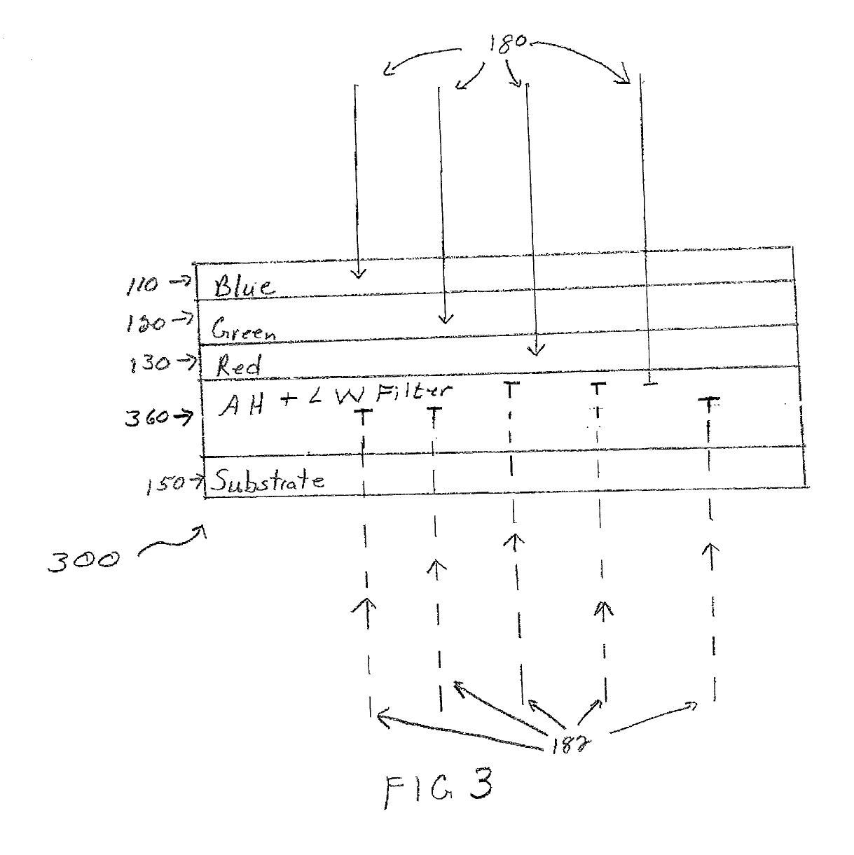

Referring next to FIG. 3, yet another embodiment of a photographic film according to the present invention is illustrated, and designated generally by reference numeral 300. Reference numerals in FIG. 3 that are like, similar or identical to reference numerals in FIGS. 1 and 2 indicate like, similar or identical features. AH Film 300, preferably comprises substrate 150, blue emulsion layer 110, green emulsion layer 120, red emulsion layer 130, and AH/LW filter layer 360. The elements of AH film 300 have been previously discussed, with the exception of AH/LW filter layer 360. AH/LW filter layer 360 is capable of preventing substantially all IR light 182 from entering emulsion layers 110, 120 and 130 from the back of AH film 300, and at the same time preventing visible light 180 from reflecting back into emulsion layers 110, 120 and 130, and forming reflected latent images. In one embodiment of the present invention, AH/LW layer 360 is a standard antihalation layer with IR absorbing dyes added. In other embodiments, a common AH layer is deposited in an extra thick layer that allows AH/LW filter layer 360 to absorb substantially all IR light 182 and visible light 180. This, in effect, enables AH/LW filter 360 to block IR light from entering emulsion layers 110, 120 and 130 from the back of AH film 300, and at the same time prevents halation (the undesired formation of latent images by reflected light).

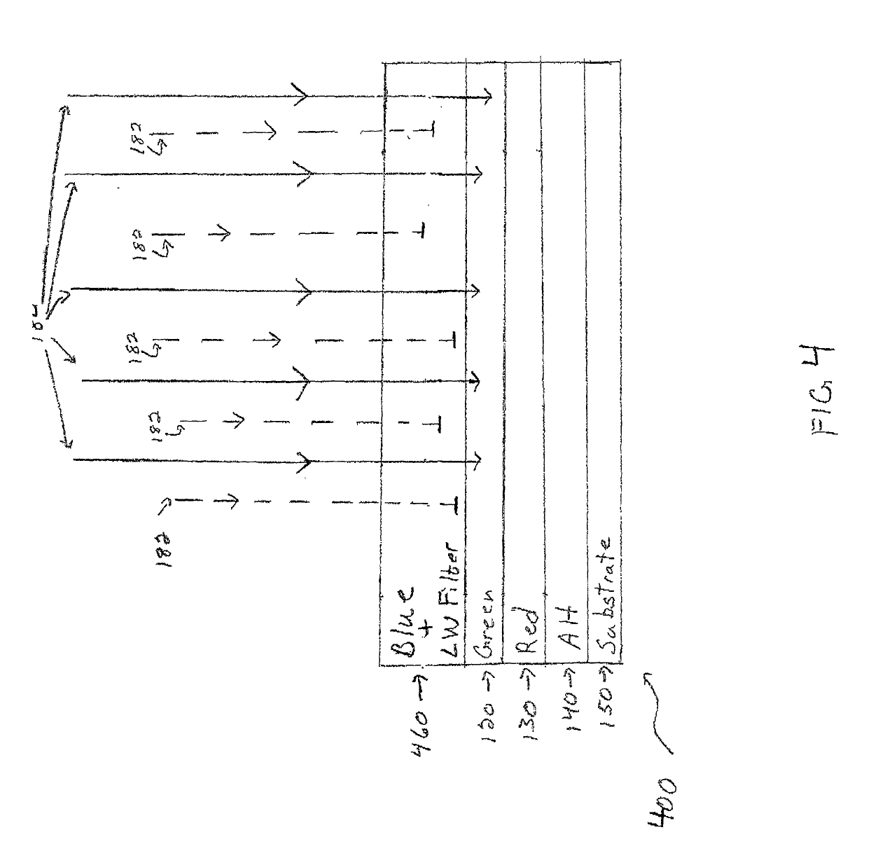

Lastly, referring to FIG. 4, another embodiment of a photographic film according to the present invention is illustrated, and designated generally as LW film 400. Reference numerals in FIG. 4 that are like, similar or identical to reference numerals in FIGS. 1-3 indicate like, similar or identical features. LW film 400 preferably comprises substrate 150, AH layer 140, red emulsion layer 130, green emulsion layer 120, and blue/LW filter layer 460. With the exception of blue/LW emulsion layer 460, the functions of each of the elements of LW film 400 have been discussed. Blue/LW emulsion layer 460 is a combined light sensitive emulsion layer and LW filter. Preferably, an emulsion layer is formulated for its desired visible light characteristics, and an IR sensitive dye is added to the emulsion. Blue/LW emulsion layer forms a latent image in response to light from the blue portion of the visible light spectrum, and allows the green and red components of visible light 180 to be transmitted to green emulsion layer 120 and red emulsion layer 130. In addition, however, blue/LW emulsion layer blocks the transmission of IR light 182, as discussed earlier.

It will be appreciated that emulsion layers other than the blue emulsion layer can be used to form a combined LW filter. For example, since IR light 182 is closer in wavelength to light from the red portion of the visible light spectrum than to other portions of the visible light spectrum, red emulsion layer 130 is more likely to be affected by IR light 182 than are green emulsion layer 120 and blue emulsion layer 110. Therefore, a combined green emulsion layer and LW filter (not illustrated) can, in some cases, be as effective as blue/LW filter 460.

Although an embodiment of the present invention has been shown and described in detail herein, along with certain variants thereof, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A photographic film comprising:
at least one light sensitive emulsion layer capable of forming a latent image upon exposure to light; and
at least one long-wavelength (LW) filter, said at least one LW filter capable of blocking transmission of substantially all light in the infra-red (IR) portion of the light spectrum.

2. The photographic film as in claim 1, wherein said at least one LW filter is further capable of allowing transmission of light in at least a portion of the visible light spectrum.

3. The photographic film as in claim 2, wherein said at least one LW filter is positioned such that when said photographic film is exposed to light in order to record a latent image, said light passes through said at least one LW filter before reaching said at least one emulsion layer.

4. The photographic film as in claim 1, wherein said LW filter comprises a dye capable of interacting primarily with light in said IR portion of the light spectrum.

5. The photographic film as in claim 1, wherein said photographic film further comprises an antihalation layer, said antihalation layer including said at least one LW filter.

6. The photographic film as in claim 1, wherein:
said photographic film has a front side and a back side, said front side being the side that is normally exposed to light in order to record a latent image and said back side being directly opposite said front side; and
wherein said at least one LW filter is positioned such that light from said IR portion of the light spectrum illuminating said back side of said photographic film can be prevented from reaching said at least one light sensitive emulsion layer.

7. The photographic film as in claim 1, further comprising a plurality of light sensitive emulsion layers sensitized to respond to different parts of the light spectrum.

8. The photographic film as in claim 7, wherein said at least one light sensitive emulsion layer comprises said at least one LW filter.

9. A method of constructing photographic film, the method comprising:
depositing at least one light sensitive emulsion layer onto a photographic film, the at least one light sensitive emulsion layer capable of forming a latent image upon exposure to light; and
depositing at least one long-wavelength (LW) filter onto the photographic film, the at least one LW filter capable of blocking transmission of substantially all light in the infra-red (IR) portion of the light spectrum.

10. The method as in claim 9, wherein the LW filter is further capable of allowing transmission of light in at least a portion of the visible light spectrum.

11. The method as in claim 10, wherein the at least one LW filter is positioned such that when the photographic film is exposed to light in order to form a latent image, the light passes through the at least one LW filter before reaching the at least one emulsion layer.

12. The method as in claim 9, wherein the LW filter comprises a dye capable of interacting primarily with light in the IR portion of the light spectrum.

13. The method as in claim 9, further comprising depositing an antihalation layer onto the photographic film, and wherein the antihalation layer comprises the at least one LW filter.

14. The method as in claim 9, wherein:
the photographic film has a front side and a back side, the front side being the side that is normally exposed to light in order to record a latent image and the back side being directly opposite the front side; and
wherein the at least one LW filter is positioned such that light from the IR portion of the light spectrum illuminating the back side of the photographic film can be prevented from reaching the at least one light sensitive emulsion layer.

15. The method as in claim 9, further comprising depositing a plurality of light sensitive emulsion layers sensitized to respond to different parts of the light spectrum.

16. The method as in claim 15, wherein the at least one light sensitive emulsion layer comprises the at least one LW filter.

17. A color photographic film comprising:
a plurality of light sensitive emulsion layers capable of forming a latent image upon exposure to light;
at least one antihalation layer; and
at least one long-wavelength (LW) filter capable of blocking transmission of substantially all light in the infra-red (IR) portion of the light spectrum.

18. The color photographic film as in claim 17, wherein said at least one LW filter is further capable of allowing transmission of light in at least a portion of the visible light spectrum.

19. The color photographic film as in claim 18, wherein said at least one LW filter is positioned such that when said photographic film is exposed to light in order to record a latent image, said light passes through said at least one LW filter before reaching said plurality of light sensitive emulsion layers.

20. The color photographic film as in claim 17, wherein said LW filter comprises a dye capable of interacting primarily with light in said IR portion of the light spectrum.

21. The color photographic film as in claim 17, wherein said antihalation layer comprises said at least one LW filter.

22. The color photographic film as in claim 17, wherein:
said photographic film has a front side and a back side, said front side being the side that is normally exposed to light in order to record a latent image and said back side being directly opposite said front side; and
wherein said at least one LW filter is positioned such that light from said IR portion of the light spectrum illuminating said back side of said color photographic film can be prevented from reaching at least one of said plurality of light sensitive emulsion layers.

23. The color photographic film as in claim 17, wherein at least one of said plurality of light sensitive emulsion layers comprises said at least one LW filter.
